(19) United States
(12) Patent Application Publication
(10) Pub. No.: US 2015/0134433 A1
(43) Pub. Date: May 14, 2015

(54) METHOD AND SYSTEM FOR AUTOMATICALLY GENERATING AND TRANSMITTING COMMUNICATIONS ACROSS MULTIPLE SOCIAL MEDIA PLATFORMS

(71) Applicant: SOCIALEYES, LLC, Philadelphia, PA (US)

(72) Inventor: Michael Muller, Philadelphia, PA (US)

(73) Assignee: SOCIALEYES, LLC, Philadelphia, PA (US)

(21) Appl. No.: 14/604,427

(22) Filed: Jan. 23, 2015

Related U.S. Application Data
(63) Continuation-in-part of application No. 14/512,253, filed on Oct. 10, 2014.
(60) Provisional application No. 61/889,484, filed on Oct. 10, 2013.

(51) Int. Cl. G06Q 30/02; G06Q 50/00

(52) U.S. Cl. CPC G06Q 30/0214; G06Q 30/0235; G06Q 50/01
USPC 705/14.16

(57) ABSTRACT

Methods and systems are disclosed regarding a social referrals platform. The platform may generate a communication including an invitation for a deal and a link to a web page. The platform may transmit the communication via email or posting to one or more social media platforms or both. Further, the platform may receive an indication that a customer user has visited the web page. The platform may also receive an indication that the customer user has accepted a set of permissions for one or more of the social media platforms. The platform may then transmit a web page including a like or follow button and a share button, wherein the buttons are related to the deal. The platform may receive indications that the customer user has pressed the buttons. The platform may transmit the deal for the customer user based on the receipt of the share button indication.

### CROSS REFERENCE TO RELATED APPLICATION

This application is a continuation-in-part of U.S. patent application Ser. No. 14/512,253 filed Oct. 10, 2014, which claims the benefit of U.S. Provisional Application No. 61/889,484 filed Oct. 10, 2013, which are incorporated by reference as if fully set forth herein.

### FIELD OF INVENTION

The disclosed embodiments are generally directed to methods and systems for customer relationship management (CRM) and for automatically generating and transmitting communications across multiple social media platforms.

### BACKGROUND

With the advent of social media, Internet marketing and multiple computing platforms, it is difficult for businesses to automate, manage and monitor all of their daily business activities on one platform and with one software solution. Conventional software solutions are not capable of integrating with all of today's application programming interfaces (APIs) and do not combine all of the tools necessary to fully manage and automate a business' daily activities, and help increase revenue. These conventional software systems rely on antiquated processes and deprecated code to manage only portions of a business' tasks. They do not understand social media, how to integrate and use it effectively. These conventional systems cannot automate, aggregate and provide consistent functionality across all platforms.

Moreover, conventional systems only perform poorly on different devices because they were designed to work on one platform. Most of the code they use is deprecated and they do not have inherent processes to that adapt themselves as the API's change. Other conventional systems only communicate to customers through traditional methods and don't create viable social networks that grow referrals.

### SUMMARY

Methods and systems are disclosed regarding an enterprise management platform that may manage and monitor all of a business' daily activities. Examples are disclosed that provide a software solution that manages and monitors activities such as marketing, payroll, online reputations, social media networks, internet advertising, mobile websites, and search engine visibility by automating, aggregating and simplifying all of these tasks in one place across all platforms. Further, examples describe an enterprise management platform that can allow a business or other organization to communicate and advertise across multiple social media platform at the same time.

The platform may contain a communications module. The module may determine the occurrence of an event selected by an administrative user to trigger a communications process. The platform may then generate a communication based on the determination and preferences of an administrative user. Further, the platform may transmit the communication to a customer user via direct messaging of one or more social media platforms based on communications preferences of the customer user. The communications preferences of the customer user may be provided after the customer user receives a welcome communication.

Further, the platform may contain a marketing module. The platform may generate a communication based on a first set of preferences of administrative user and an advertisement based a second set of preferences of an administrative user. The platform may transmit the advertisement via a social media platform selected based on the second set of preferences. The platform may also transmit the communication via one or more social media platforms based on the first set of preferences. Further, the platform may receive an indication that a customer user has visited the web page and has activated a remarketing code.

A social referrals platform may operate in conjunction with the enterprise management platform or on a stand-alone basis. The social referrals platform may generate a communication including an invitation for a deal and a link to a web page. The social referrals platform may transmit the communication via email or posting to one or more social media platforms or both. Further, the social referrals platform may receive an indication that a customer user has visited the web page. The social referrals platform may also receive an indication that the customer user has accepted a set of permissions for one or more of the social media platforms. The social referrals platform may then transmit a web page including a like or follow button and a share button, wherein the buttons are related to the deal. The social referrals platform may receive an indication that the customer user has pressed the like or follow button and an indication that the customer user has pressed the share button. Accordingly, the social referrals platform may transmit the deal for the customer user based on the receipt of the share button indication. The administrative user may use the social referrals platform to set preferences for the deal.

### BRIEF DESCRIPTION OF THE DRAWINGS

A more detailed understanding may be had from the following description, given by way of example in conjunction with the accompanying drawings wherein:

FIG. 1 illustrates an example of a network environment for a digital business and social media communications platform;

FIG. 2 illustrates an example computing device that may be used to implement features described herein as performed by the enterprise management platform;

FIG. 3 illustrates a computer tablet that is a more specific example of the computing device;

FIG. 4 illustrates an example use of the enterprise management platform by an administrative user;

FIG. 5 illustrates an example of a process the platform may perform to generate direct messages to the customer user;

FIG. 6 illustrates an example of a process the platform may perform to obtain communications preferences of the customer user;

FIG. 7 illustrates an example of a web page where an administrative user may indicate communications preferences;

FIG. 8 illustrates an example of a web page where a customer user may indicate communications preferences;

FIG. 9 illustrates an example of a web page where an administrative user may indicate communications preferences for a particular automated communication;

FIG. 10 illustrates an example of a process the platform may perform to generate and transmit advertisements and related communications;

FIG. 11 illustrates an example of an administrative user creating a marketing communication;

FIG. 12 illustrates an example of an administrative user refining a marketing communication;

FIG. 13 illustrates an example of an administrative user creating an advertisement;

FIG. 14 illustrates an example of a marketing communication transmitted to a customer user;

FIG. 15 illustrates an example of a web page which contains remarketing code;

FIG. 16 illustrates an example of an advertisement received by a customer user;

FIG. 17 illustrates an example of a process where the customer user may obtain deals using the social referrals platform;

FIG. 18 illustrates an example of a web page transmitted by the social referrals application displaying like and share buttons related to a deal;

FIG. 19 illustrates an example of a customer user's timeline on a social media platform displaying a post related to a deal;

FIG. 20 illustrates an example of a coupon related to a deal;

FIG. 21 illustrates an example of a process where the administrative user may create and activate new deals using the social referrals platform;

FIG. 22 illustrates an example of a web page where an administrative user may indicate deal preferences;

FIG. 23 illustrates an example of a web page where an administrative user may enter general deal settings using the social referrals platform; and

FIG. 24 illustrates an example of a web page where an administrative user may add a coupon to more or more deals using the social referrals platform.

### DETAILED DESCRIPTION

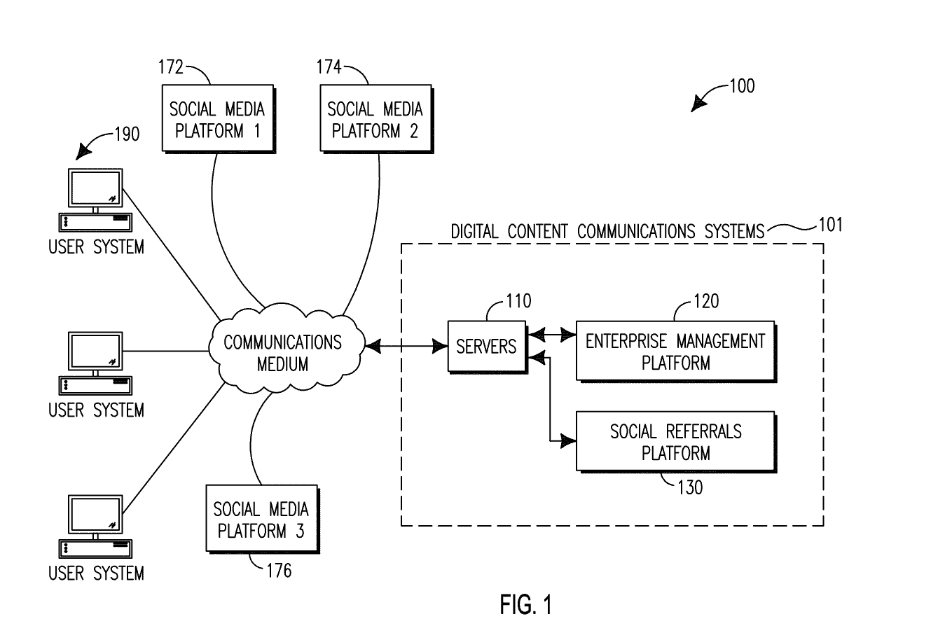

FIG. 1 illustrates an example of a network environment for a digital business and social media communications platform. The network environment 100 may include a digital content communications system 101 that may be implemented using one or more computing systems, such as servers 110. The digital content communications system 101 may also be implemented as a network resource, such as a website or similar resource. In certain examples, the digital content communications system 101 may generate communications, advertisements or promotions corresponding to preferences of an administrative user and customer users.

The digital content communications system 101 may be accessed by users via computer user systems 190. Although shown as personal computers (PCs) for purposes of illustration, the user systems 190 may include various other types of computing devices, such as web pads, personal digital assistants (PDAs), mobile phones, set-top television boxes, media players, laptop computers, tablets, desktop computers, electronic book readers, kiosks, and similar systems. The user systems 190 may include various software applications for accessing the digital content communications system 101, such as browser software applications, stand-alone software applications, plug-ins, interfaces, and combinations of the same and similar applications.

The digital content communications system 101 may include one or more servers 110 for communicating with the user systems 190 over a communications medium 180, which may be a network such as the Internet, a local area network (LAN) or wide area network (WAN), intranet, or similar communications media. The servers 110 can be web servers in some embodiments. As web servers, the servers 110 may process Hypertext Transfer Protocol (HTTP) and other protocol requests received over the communications medium 180 from the user systems 190. Additional protocols and components for providing communication between the user systems and servers via the communication medium 180 may be provided in various implementations. Further, the servers 110 may be located in the cloud.

The digital content communications system 101 may include an enterprise management platform 120, which may be a software component for generating communications, advertisements and promotions by administrative users for customer users. The administrative users and customer users may employ the user systems 190. The enterprise management platform 120 may be accessed by the user systems 190 through the servers 110. The enterprise management platform 120 may generate communications, advertisements and promotions based on the preferences of administrative users and customer users.

The digital content communications system 101 may include a social referrals platform 130, which may be a software component for generating social referral communications, by administrative users for customer users to use and distribute. The social referrals platform 130 may also be accessed by the user systems 190 through the servers 110. The social referrals platform 130 may generate social referral communications based on the preferences of administrative users and customer users.

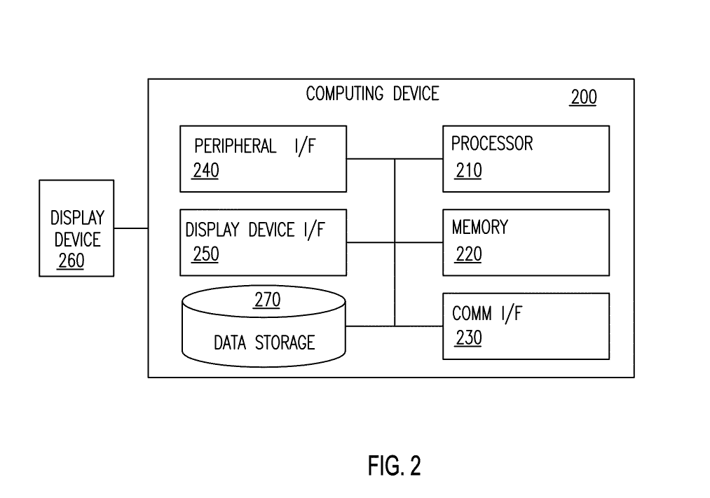

FIG. 2 illustrates an example computing device that may be used to implement features described herein as performed by the platform. Accordingly, an instance of the computing device 200 may be used to implement features of a server 110, user system 190, desktop computer, laptop computer, tablet computer, smartphone, or similar device. The computing device 200 includes a processor 210, memory device 220, communication interface 230, peripheral device interface 240, display device interface 250, and data storage device 270. FIG. 2 also shows a display device 260, which may be coupled to or included within the computing device 200.

As used herein, the term “processor” refers to a device such as a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), a state machine, or a similar type of device.

The memory device 220 may be or include a device such as a Dynamic Random Access Memory (D-RAM), Static RAM (S-RAM), other RAM or a flash memory. Further, memory device 220 may be a device using a computer-readable medium. The data storage device 270 may be or include a hard disk, a magneto-optical medium, a solid-state drive (SSD), an optical medium such as a CD-ROM, a digital versatile disk (DVDs), or Blu-Ray disc (BD), or other type of device for electronic data storage. Further, data storage device 270 may be a device using a computer-readable medium. As used herein, the term “computer-readable medium” refers to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

The communication interface 230 may be, for example, a communications port, a wired transceiver, a wireless transceiver, and/or a network card. The communication interface 230 may be capable of communicating using technologies such as Ethernet, fiber optics, microwave, xDSL (Digital Subscriber Line), IEEE 802.11 technology, Wireless Local Area Network (WLAN) technology, wireless cellular technology, or any other appropriate technology.

The peripheral device interface 240 is configured to communicate with one or more peripheral devices. The peripheral device interface 240 operates using a technology such as Universal Serial Bus (USB), PS/2, Bluetooth, infrared, serial port, parallel port, FireWire and/or other appropriate technology. The peripheral device interface 240 may, for example, receive input data from an input device such as a keyboard, a mouse, a trackball, a touch screen, a touch pad, a stylus pad, or other device.

The display device interface 250 may be an interface configured to communicate data to display device 260. The display device 260 may be, for example, a monitor or television display, a plasma display, a liquid crystal display (LCD), or a display based on a technology such as front or rear projection, light emitting diodes (LEDs), organic light-emitting diodes (OLEDs), or Digital Light Processing (DLP). The display device interface 250 may operate using technology such as Video Graphics Array (VGA), Super VGA (S-VGA), Digital Visual Interface (DVI), High-Definition Multimedia Interface (HDMI), or other appropriate technology. The display device interface 250 may communicate display data from the processor 210 to the display device 260 for display by the display device 260. As shown in FIG. 2, the display device 260 may be external to the computing device 200, and coupled to the computing device 200 via the display device interface 250. Alternatively, the display device 260 may be included in the computing device 200. An instance of the computing device 200 of FIG. 2 may be configured to perform any feature or any combination of features of the system and method described herein as performed by digital content communications system 101 or platform.

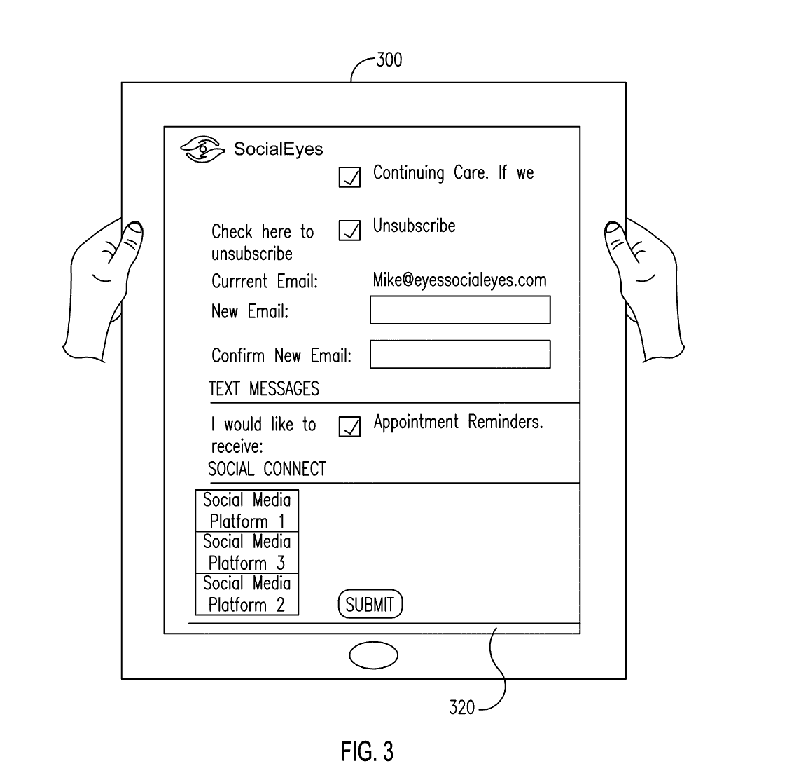

FIG. 3 illustrates a computer tablet that is a more specific example of the computing device 200 of FIG. 2. The computer tablet 300 may include a processor (not depicted), memory device (not depicted), communication interface (not depicted), peripheral device interface (not depicted), display device interface (not depicted), storage device (not depicted), and touch screen display 320, which may possess characteristics of the processor 210, memory device 220, communication interface 230, peripheral device interface 240, display device interface 250, storage device 270, and display device 260, respectively, as described above with reference to FIG. 2. The touch screen display 320 may receive user input using technology such as, for example, resistive sensing technology, capacitive sensing technology, optical sensing technology, or any other appropriate touch-sensing technology.

As used herein, an enterprise management platform may be used interchangeably with an enterprise management system, a business management platform, business management system, business management application or software application. As used herein, a social referrals platform may be used interchangeably with a social referrals system, a social referrals application and a social referrals module.

As disclosed herein, examples demonstrate a software solution that can work across multiple platforms to provide an integrated system for managing and monitoring all of a business' daily activities. Further, examples describe an enterprise management platform that can allow a business or other organization to communicate across multiple social media platforms at the same time. The social media platforms may include FACEBOOK, TWITTER, GOOGLE PLUS and other social media platforms. The enterprise management platform may also operate as a social media platform and may interact with the social referrals system, which may also operate as a social media platform. The business' daily activities may include marketing, payroll, online reputations, social media networks, internet advertising, mobile websites, and search engine visibility. The platform may automate, aggregate and simplify all of these tasks in one place across all platforms.

In an example, the platform automates the marketing experience across all platforms and allows business users, such as administrative users, to manage it from anywhere. The software application improves communication by engaging customers through more than just traditional methods, like direct messaging and inboxing. Referrals may be generated through all networking channels. Back and front office tasks may be automated and an ongoing stream of communication may be reached with customers. In an example, processes may be built into the software application to adapt itself to the new application programming interfaces (APIs) as they change, thereby automatically evolving with their environment.

An administrative user could use the software to communicate, market and advertise to their customers, who may be customer users. Administrative users can integrate the software application into their customer relationship management (CRM) system and customize each feature's settings to market, advertise and communicate with their customers automatically and on a reoccurring basis. For example, administrative users may customize and update their preferences regarding marketing, advertisements and communication with customer users. Administrative users could use the platform to gain exposure on the internet and social media by updating their customers through social media platforms managed by the software. Further, administrative users can use the platform to track their earnings that come directly from using the platform. Users can perform the multiple and various functions of many other software applications by using the software application of the platform instead of multiple conventional applications. Administrative users can perform the task of having customers connect to their social networks in the office, where it is most important to approach them.

In an example, once the software is installed and the connection is made to the administrative user's database, the administrative user may go to a particular website and log on with their credentials. The administrative user will be presented with a settings screen. Here they can customize most of the logic that performs the overall functions and features of the software. The administrative user may set up each feature in the software or they may use the defaults. The logic may be mostly based on communications sent to customer users. There may be many different communication types such as welcome messages, appointment reminders, follow-up, thank-you, products are ready, birthday greetings, referrals, and reviews, as just a few examples. These communications may be primarily triggered by time-based events which come from either a customer's personal profile information or appointments, financial transactions, or marketing. When using the appointments feature, an administrative user may choose specific time intervals when the reminders and confirmations should go out, which may be based on the day and time the appointments occur. In cases such as birthdays and continuing care messages, this information may be triggered by personal profile queries. Thank you, continuing care and survey or review communications may be triggered by financial information on the customer. The social media features within the software may be based upon application language interfaces and authorization codes. Administrative users may login with their social media information and communicate with their customer users using the platform. The software application's social media module may be fed by a constant stream of information pertinent to the industry in which the business is operating. The software may contain a code that refers to the type of business that triggers which type of social media information will be streamed in. The platform can contain settings allowing the administrative user to use that information in e-mails or text messages, social media posts, newsletters, and other types of communications.

The platform may typically be hosted on the Cloud and operated as a Software as a Service (SaaS). The software may interface with a business' electronic CRM system using a CRM Interface program which may reside on the administrative user's server or PC to transfer data to and from each other. There may also be one or more computer tablets, such as computer tablet 300, that may reside in the administrative user's business location and may contain a proprietary customer relationship management and social networking application. The application may be called, for example, “Social Referrals.” The customers of the business may be customer users and may use the software application to connect to the business' CRM and social media platforms.

The software application can include five main user areas. The five main areas may include Business Information, Features, Settings, Support and Customer Information. The business information area may house business profile information, such as phone number, address, website, and the like. The features area can perform the day to day functions of the software application. The settings area may allow features to be customized based on user preferences. The support area may provide support for the administrative users as well as knowledge bases. Finally, the customer information area may include data about the customer, as pulled in from the CRM system. This data may be stored in the customer information area to trigger events. This area may contain features that represent, for example, a list of patients, records, demographics, social media, interaction, friends lists, referrals, and the like.

These areas may house several interchangeable modules that contain multiple features and settings. Each module may contain settings to customize each of the features within the module. Each of these areas may share information with each other that populate fields within each other's features. Events within the features may be triggered by information contained in the settings for each feature.

A first module may be the customer communication module. This module may be composed of several features including appointment confirmation and scheduling and other features such as referral request, surveys and more. Each feature may use one or all of four different communication channels to deliver them—social media, email, SMS text or phone. Each of the features in the module may have customizable settings that allow users to turn features on and off, modify messaging, control scheduling and triggering.

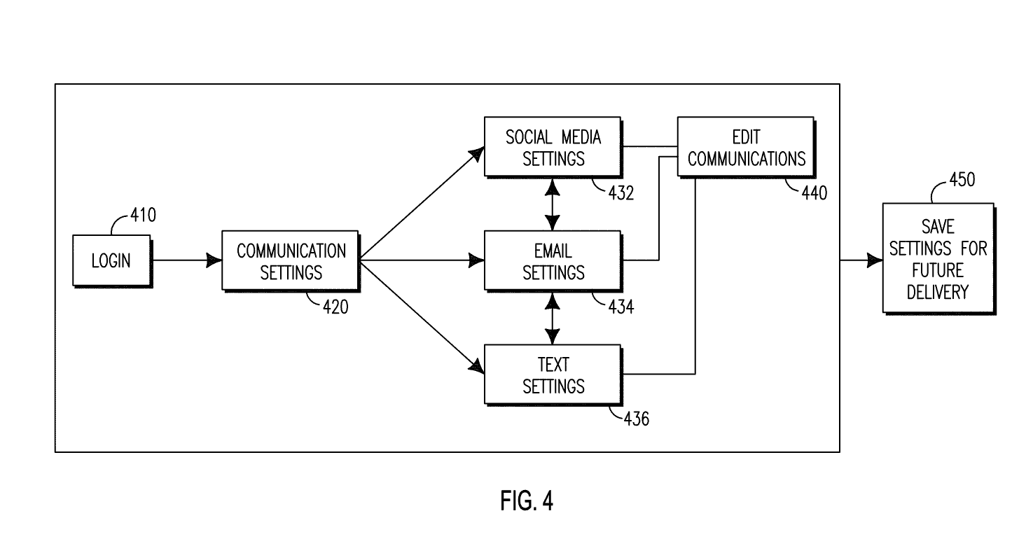

FIG. 4 illustrates an example use of the enterprise management platform by an administrative user. The administrative user may login 410 and choose either the marketing or communications section. In an example, the administrative user may choose one of the links under communications settings 420, which then may lead the administrative user to the social media settings 432, emails settings 434 or text settings 436 pages. The administrative user may then prepare and edit the communications 440 to be sent to the customer users. When the administrative user is satisfied with the communications settings, the administrative user may save these settings for the future delivery of the communications 450 to the customer users, as described further below.

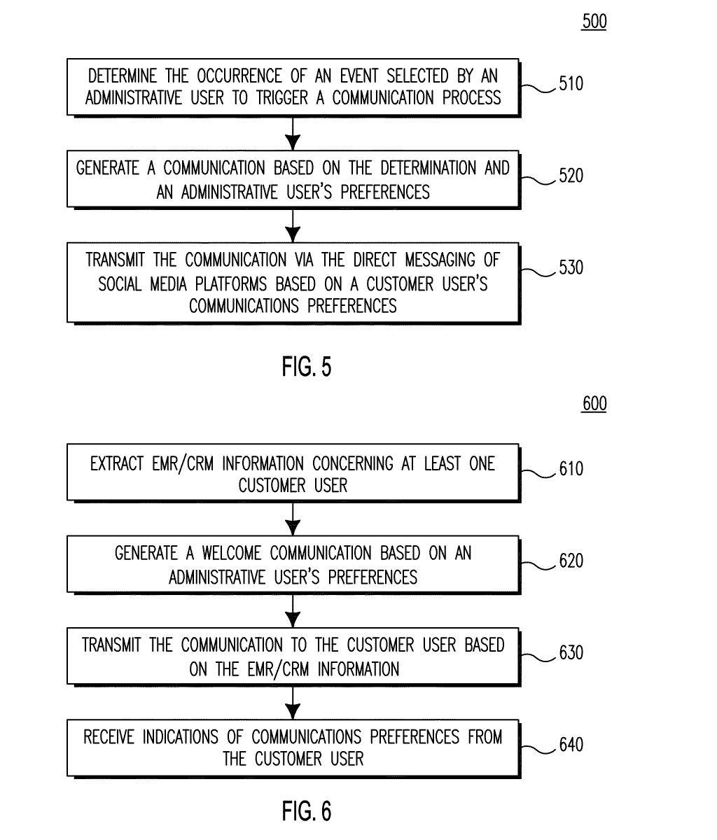

FIG. 5 illustrates an example of a process the platform may perform to generate direct messages to the customer user. The platform may begin the process 500 by determining that an event has occurred 510 which is of a type previously selected by an administrative user as a trigger for communications with a customer user. For example, the platform may determine that a customer user has an appointment in a week and the administrative user may have previously indicated that a reminder communication may go out to a customer at that time. The platform may then generate a reminder communication 520 based on this communication. The content, form, frequency and type of communication, as well as other settings, may be determined by the administrative user to reflect the administrative user's preferences, as described further below. The platform may then transmit the generated communication via the customer user's previously indicated communications preferences 530. For example, if the customer user indicated one or more social media platforms as a communications preference, the platform may transmit the reminder via those platforms.

FIG. 6 illustrates an example of a process the platform may perform to obtain communications preferences of the customer user. In an example process 600, the platform may extract information concerning customer users such as electronic medical records (EMR) or CRM 610 information. The platform may extract this information, for example, from sources and databases maintained by the administrative user or from other sources. The platform may generate a welcome communication, such as a welcome email, based on the administrative user's preferences 620. The administrative user may have previously entered preferences into the platform. The platform may transmit the welcome communication to the customer user based on the EMR information, the CRM information or both. The customer user may view the welcome communication, click on a link in the communication and navigate to a web page. The platform may then receive indications of communications preference from the customer user 640. For example, the customer user may indicate that a social media platform is the preferred method of communication to the customer user, as explained further below. As another example, the customer user may indicate that two social media platforms are the preferred method of communication.

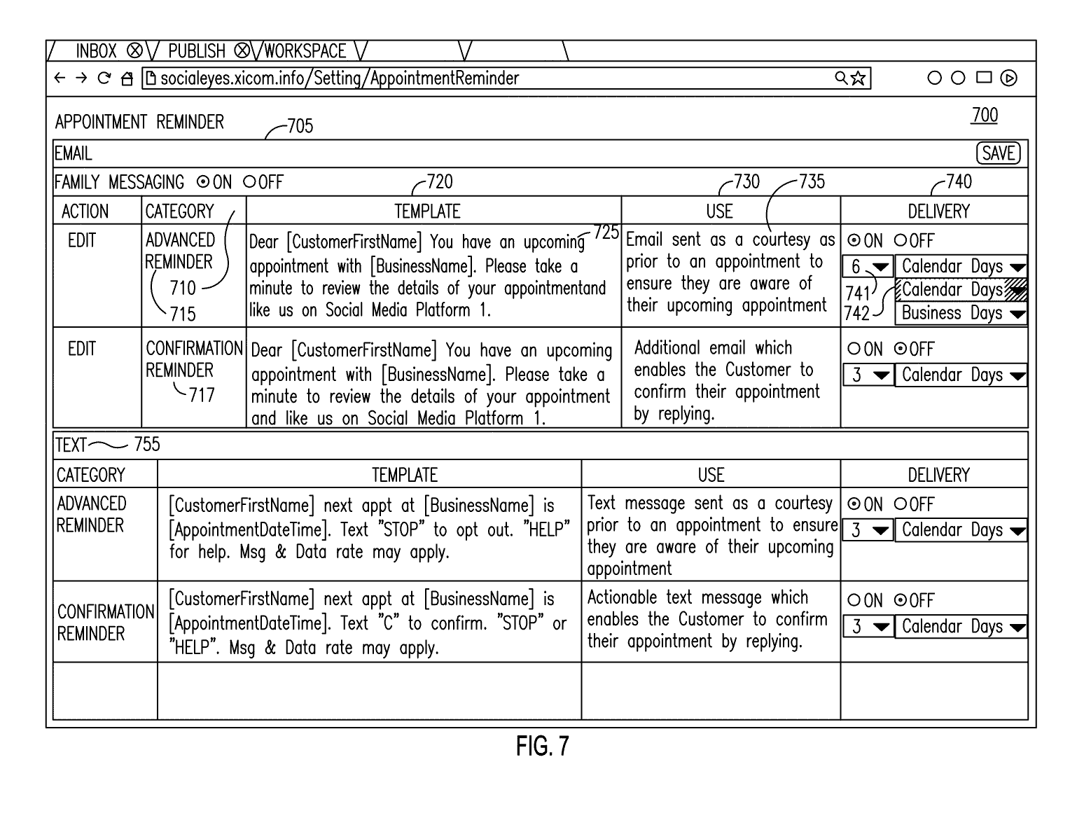

FIG. 7 illustrates an example of a web page where an administrative user may indicate communications preferences. The administrative user may navigate to the web page 700 using different links on the platform. On the web page 700, the administrative user may provide preferences for email 705, text messages 755 or direct messaging on social media platforms (not shown). The administrative user may provide preferences regarding the event to trigger the communication, the frequency of the communication and the message content of the communication. For email 705, for example, the administrative user may determine the category 710, template 720, use 730 and delivery time or frequency 740 of the communication. For example, the administrative user may edit an advance reminder 715. As explained under use 730, the advance reminder email may be sent prior to a customer user's appointment to ensure the customer user is aware of the appointment 735. The reminder may be provided to customer users who have scheduled appointments. The administrative user may modify the advanced reminder template message 725. The administrative user may also determine how far in advance to set the platform to transmit the reminder. As an example, the platform may send the reminder six (6) 741 calendar days 742 before the appointment. The platform may then store these preferences and apply them when a trigger, such as six (6) days before an appointment, is determined.

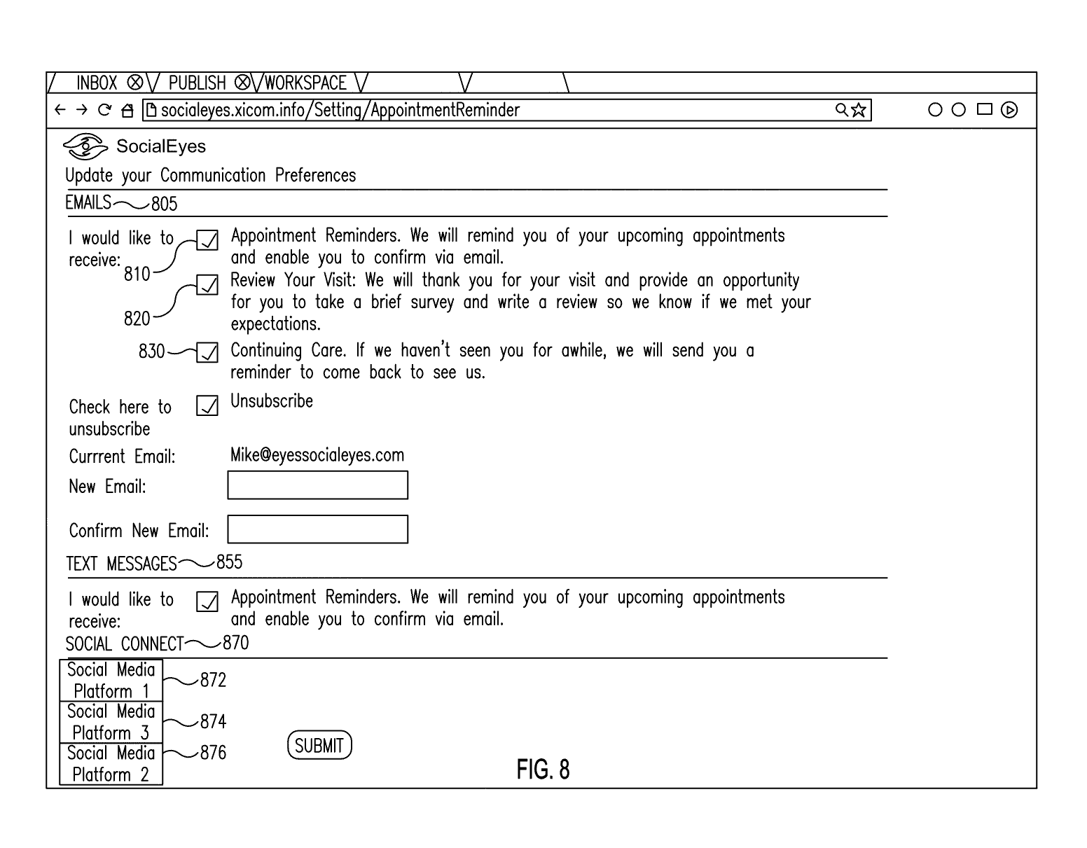

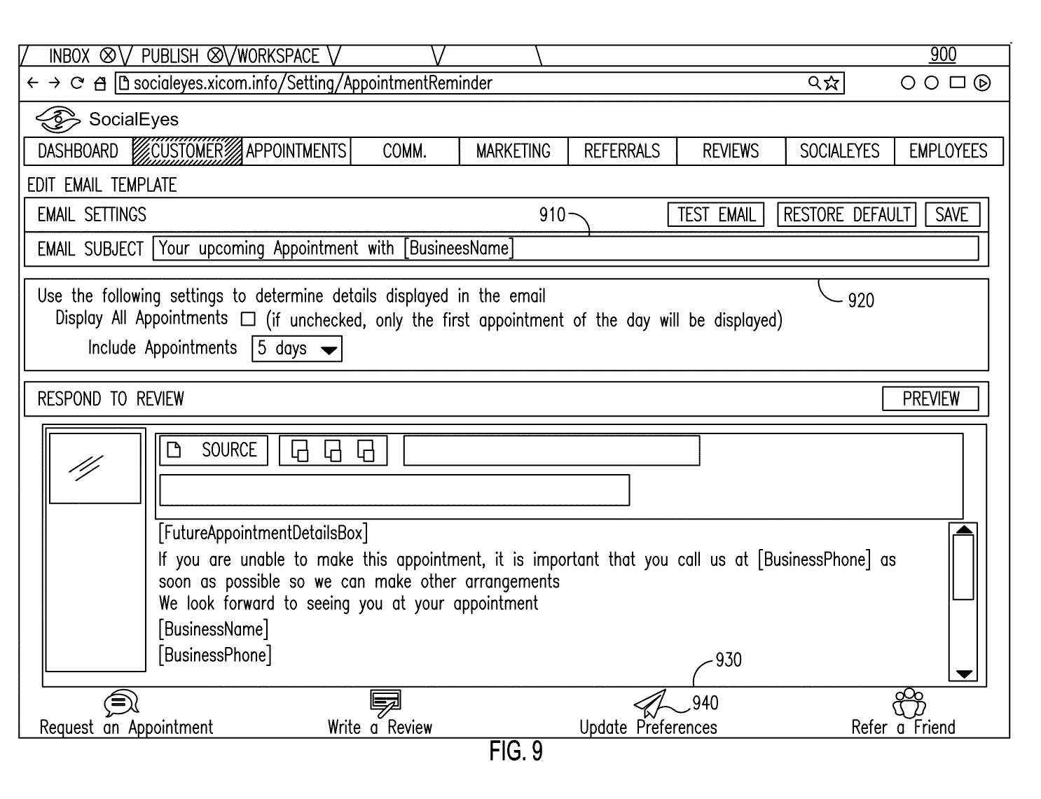

FIG. 8 illustrates an example of a web page where a customer user may indicate communications preferences. After receiving the welcome communication, the customer user may click on a link that directs the customer user to a web page to provide communications preferences. The customer user may provide, and later may update, communications preferences for email 805, text messages 855 or direct messaging via social media 870. The customer users may indicate the types of communications they prefer to receive, such as appointment reminders 810, reviews of a visit 820, a continuing care 830 reminder to suggest visiting the business, a product ready for pickup notice, special offers, newsletters, birthday greetings, and the like. The customer user may also indicate which social media platforms they prefer to receive direct messages over, such as a social media platform 1 872, social media platform 2 874, social media platform 3 876, and the like.

FIG. 9 illustrates an example of a web page where an administrative user may indicate communications preferences for a particular automated communication. In an example, the administrative user may navigate to a web page 900 to prepare a form email and set related preferences. The administrative user may enter the subject of the form email 910, such as a reminder of an upcoming appointment or a continuing care reminder (not shown). The administrative user may indicate preferences 920 regarding the automated email, including whether the email should display upcoming appointments of the customer user receiving the email and how many days in advance should be searched for upcoming appointments. The administrative user may edit the text 930 of the automated email. The email or other communication may also include an update preferences link 940 that the customer user may click to navigate to the web page where the communications preferences of the customer user may be provided or updates, as described above. Once set, the administrative user may save the email settings and administrative user's preferences. The platform may use the form email and the settings to send communications, such as appointment reminders, to the customer users when a trigger is reached, such as 6 days before an appointment, as described above.

A second module of the platform may be the reputation management module. This module may include several features including, reviews, surveys, reputation tracking and more. Each feature may have its own settings to control notifications and communications to achieve its primary functions.

A third module may be the marketing module. This module may contain several marketing features including social media, email, newsletter, text, internet, FACEBOOK and GOOGLE ADWORDS marketing, and the like. Settings for each of these features may allow for their customization.

A fourth module may be the social media module. This module may be used to communicate with customers on social media platforms as well as receive content pertinent to the customer's industry which the software finds for them. This module may contain settings for each feature to customize them.

A fifth module may be the employee tracking module. Here, features such as time card, sick and vacation tracking may be displayed. Settings for each of these features may allow for each to be customized.

A sixth module may be the mobile packager module. This module's features may create a mobile site based on all the content pulled from the users profile. The settings may allow for drag and drop customization.

A seventh module may be the results module, housing the features for tracking revenue, campaign results, referrals and more. There may also be settings to customize this module as well.

An eighth module may be the B-to-B community network. There may be several features in here, such as other closely geo-located businesses, specials they are running, and more. There may be a setting that adjusts these features.

A ninth module may be the group purchasing module with features that allow businesses to communicate with vendors about products they are looking for as well as with other businesses looking for the same products.

A tenth module may be the review module. This module may contain features that display survey results and reviews.

The appointment scheduler may be the eleventh module. This module may be connected to all the other modules.

A twelfth module may be the social referrals system module. The social referrals system module may be connected to all the other modules and may enhance a business' communication and marketing using social media. The module may create promotions, offers or deals which may be shared and spread using social media platforms.

The marketing module, which may allow administrative users to create ads newsletters and posts will also be triggered by time and events, financial transactions, personal profile information. If the customer of the platform, for example, an administrative user, creates an advertisement that can be distributed through many different advertising channels and if they are using social media research platforms the advertisement may use APIs to create ads on those platforms. Those ads can also trigger e-mails and other types of communications to go out with that advertising information. These ads can also be triggered by financial transactions or purchases that the customer has made. Also, personal profile information such as birthdays can trigger ads or demographics. When communications are sent out, communications may contain information on other businesses in the area of the person who received the communication. For example, a person in Los Angeles, Calif. receiving communications may see other businesses in their area but not the same type of business the communication was coming from. The information displayed on the social referrals network may be triggered by geographic targeting. His business communication through the referral network may contain a link to their social referrals network profile and any type of advertising that they are doing through the software application.

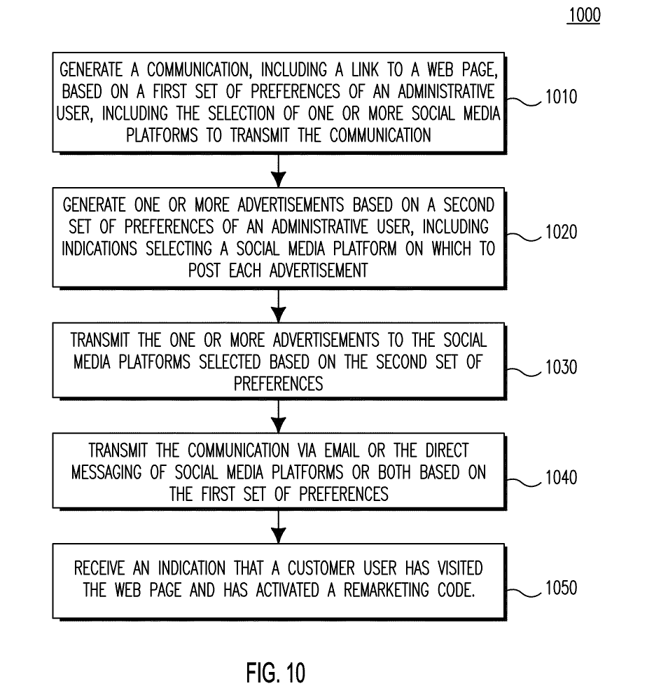

FIG. 10 illustrates an example of a process the platform may perform to generate and transmit advertisements and related communications. The platform may begin a process 1000 with the generation of a communication that may lead to a customer user viewing an advertisement. As an example, the platform may generate a communication 1010, such as an email or direct message via a social media platform, which includes a link to a web page. The platform may generate the communication based on preferences of an administrative user. As described below, the administrative user may provide the preferences to the platform, which may save the preferences. The preferences may include the selection of one or more social media platforms which the communication are to be sent and which may direct message the communication to the customer user. The preferences may also include the selection of email as the means to send the communication. The platform may then generate one or more advertisements to send to customer users, based on further preferences of an administrative user 1020. The preferences may include the selection of a social media platform on which to post the advertisement. Multiple advertisements can be created and each may use a different social media platform. Multiple advertisements, each using a different social media platform, may be associated with a single communication. The administrative user may choose to create an advertisement as a pay per click advertisement. Further, the administrative user may post the communication to a social media platform as a pay per click advertisement.

The platform may then transmit the advertisements to one or more of the social media platforms selected by the further preferences 1030. Further, the platform may transmit the communication to a customer user. The communication may be transmitted via email or a social media platform 1040 or both, depending upon the administrative user's preferences, as described above. The communication may be transmitted via multiple social media platforms based on the preferences, as explained further below.

The communication may then be direct messaged via the selected social media platform to a customer user. The customer user may receive the communication based on the communication preferences, as described above. The customer user may open the communication and click on the link in the communication, as explained further below. As a result, the customer user may be directed to a web page. The web page may be a landing page or the hypertext markup language (HTML) version of the communication. The customer user may then activate a remarketing code. This remarketing code may then trigger the transmission of the advertisement to the customer user. The customer users may view the advertisement on, for example, their social media platform page. Further the remarketing code may enable further advertisements to be provided to the customer user. The platform may receive an indication that the customer user has activated the remarketing code 1050. The transmission of the advertisement to the customer user may also be triggered by the inherent triggers of the social media platforms, such as, for example, customer user interests, demographics, geography and the like.

As a further example, the communications or advertisements or both may contain links to a social referrals deal and may bring the customer user to the social referrals platform. For example, the customer may be directed to the social referrals platform's landing page. The customer user may then begin the process of deal sharing via the social referrals platform. For example, when social media friends or followers click on the link to the social referrals platform, they may have the option to receive the deal as well, by sharing the deal in turn. They may also automatically be served with the advertisements triggered by a remarketing code placed on the social referrals platform's landing page.

As a further example, advertisements may also be transmitted to the customer user based on triggers related to the customer user's social media interests and profile preferences. The advertisements may be created by the platform. The advertisements may include, for example, pay per click ads, promoted posts, offers and the like.

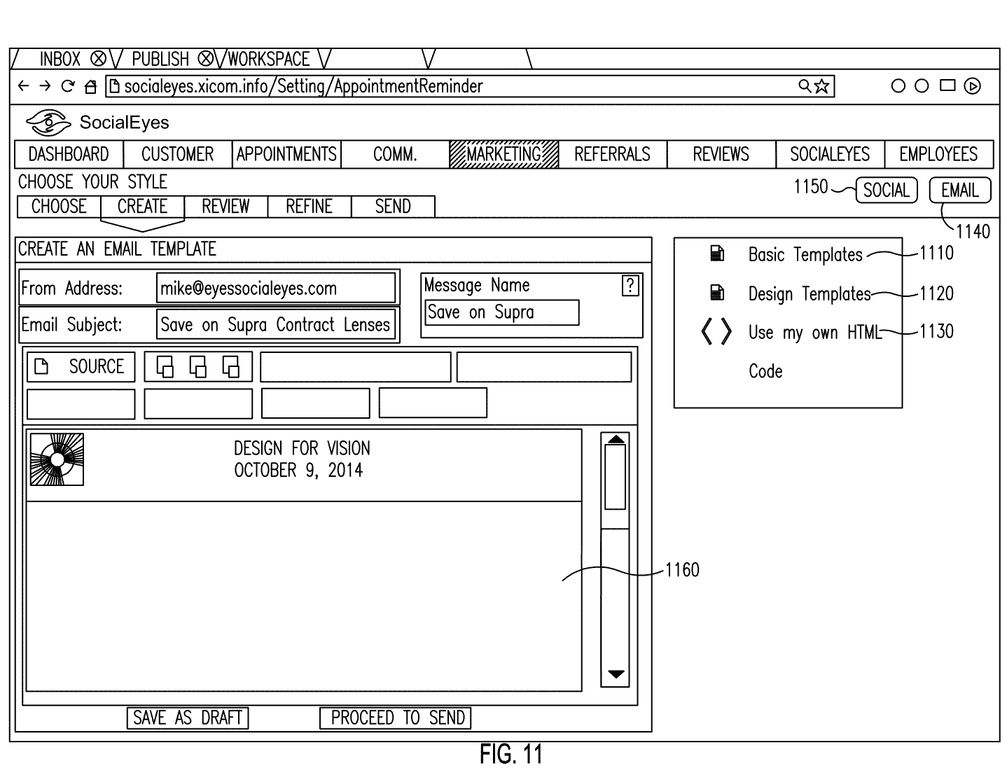

FIG. 11 illustrates an example of an administrative user creating a marketing communication. The communication may include various marketing communications, such as, for example, promotions, deals, offers and the like. The administrative user may select preferences regarding the communication, such as the use of a basic template 1110, a design template 1120 or the user of the administrative user's own HTML code 1130. The administrative user may provide preferences regarding the use of email 1140 or social media platforms 1150 to transmit the message. The administrative user may enter and edit text and graphics regarding the communication 1160. The administrative user may also choose to use a communication, such as a deal, that the user created using the social referrals module.

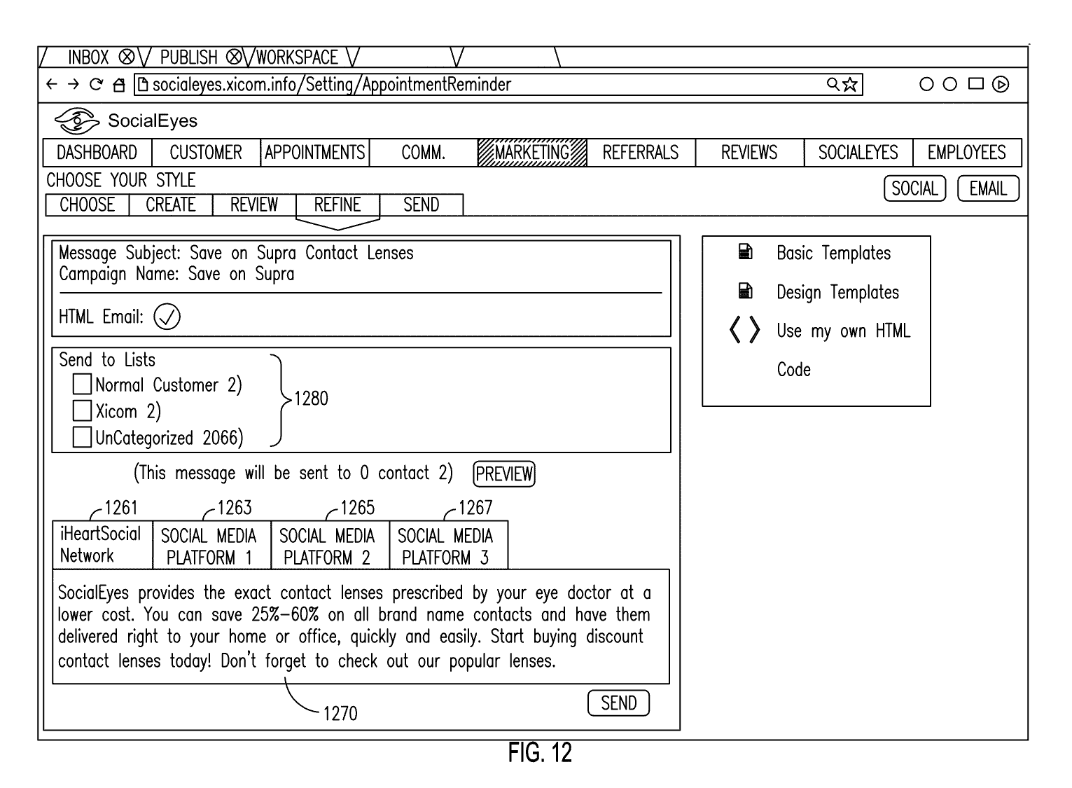

FIG. 12 illustrates an example of an administrative user refining a marketing communication. After creating the communication, the administrative user may refine it. The administrative user may view the message contents as they would appear in a form for transmission via social media 1270. The administrative user may further edit or refine the communication at this point. After the administrative user completes the communication, the platform may transmit an email with the communication and may also or alternatively post the communication to one or more social media profiles of the administrative user. In an example, the administrative user may choose to post to social media profiles that may reside on social media platforms including one or more of the enterprise management platform's social media platform 1261, social media platform 1 1263, social media platform 2 1265, social media platform 3 1267, and the like. As described above, the communication may be posted to social media platforms as a pay per click advertisement. The communication may also be posted to the social media profile of the administrative user maintained by the enterprise management platform 120 or social referrals platform 130 or both.

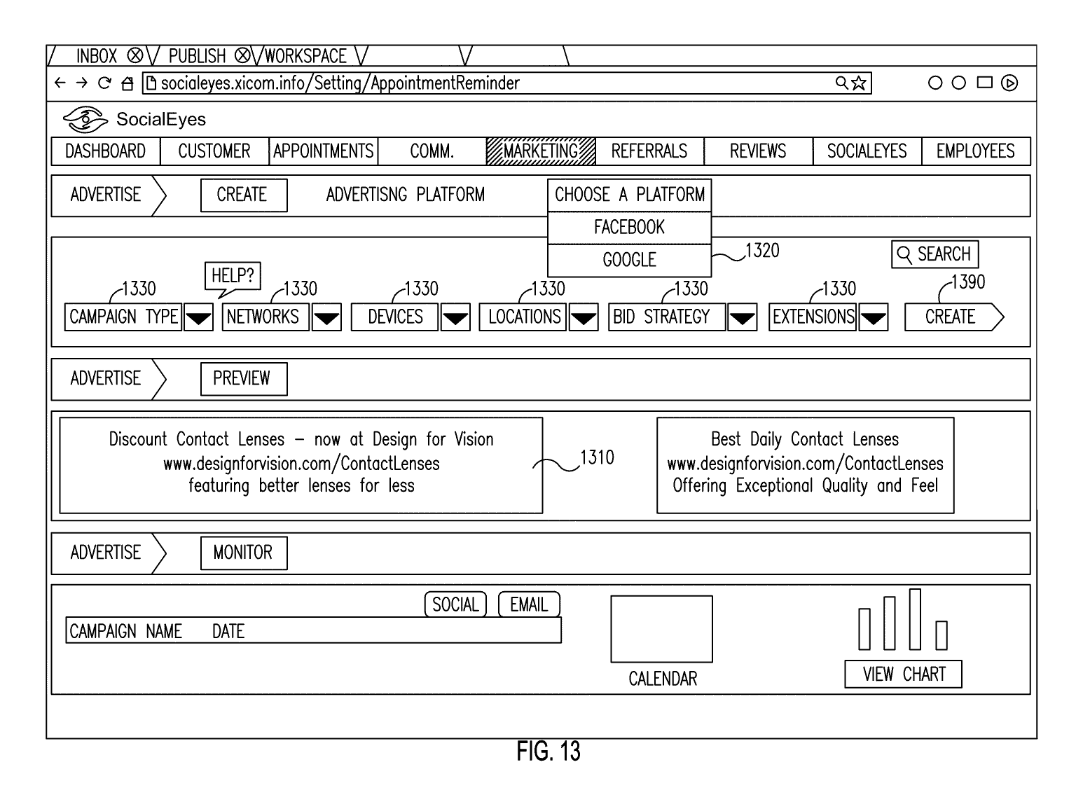

FIG. 13 illustrates an example of an administrative user creating an advertisement. The administrative user may create and edit text and graphics for the advertisement 1310. The administrative user may indicate preferences regarding which social media platform the advertisement should be transmitted to 1320. The administrative user may provide indications of further preferences 1330, such as, for example, campaign type, networks, devices, locations, bid strategy, extensions, and the like. The administrative user may then save and create the advertisement on the selected social media platforms by clicking the “Create” button 1390. The enterprise management platform may then transmit the advertisement to the social media platform selected by the administrative user, as indicated by the administrative user's preferences. The enterprise management platform may use the APIs of the social media platforms to create and display the transmitted advertisements. As a result, the administrative user may not need to leave the enterprise management platform go to the social media platforms to place the advertisements.

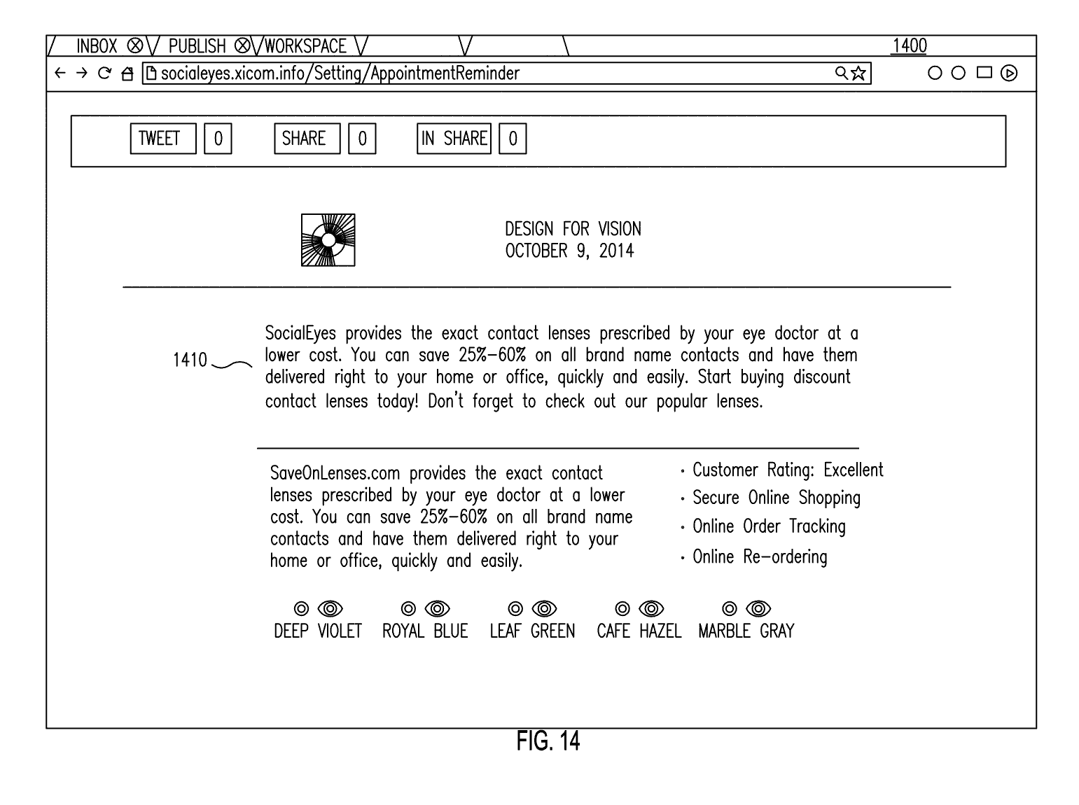

FIG. 14 illustrates an example of a marketing communication transmitted to a customer user. The marketing communication 1400 may be an email or direct message on social media. The customer user may click on any part of the marketing communication presented 1410 to the customer user. The customer user may then be directed to a web page which contains remarketing code, as described above.

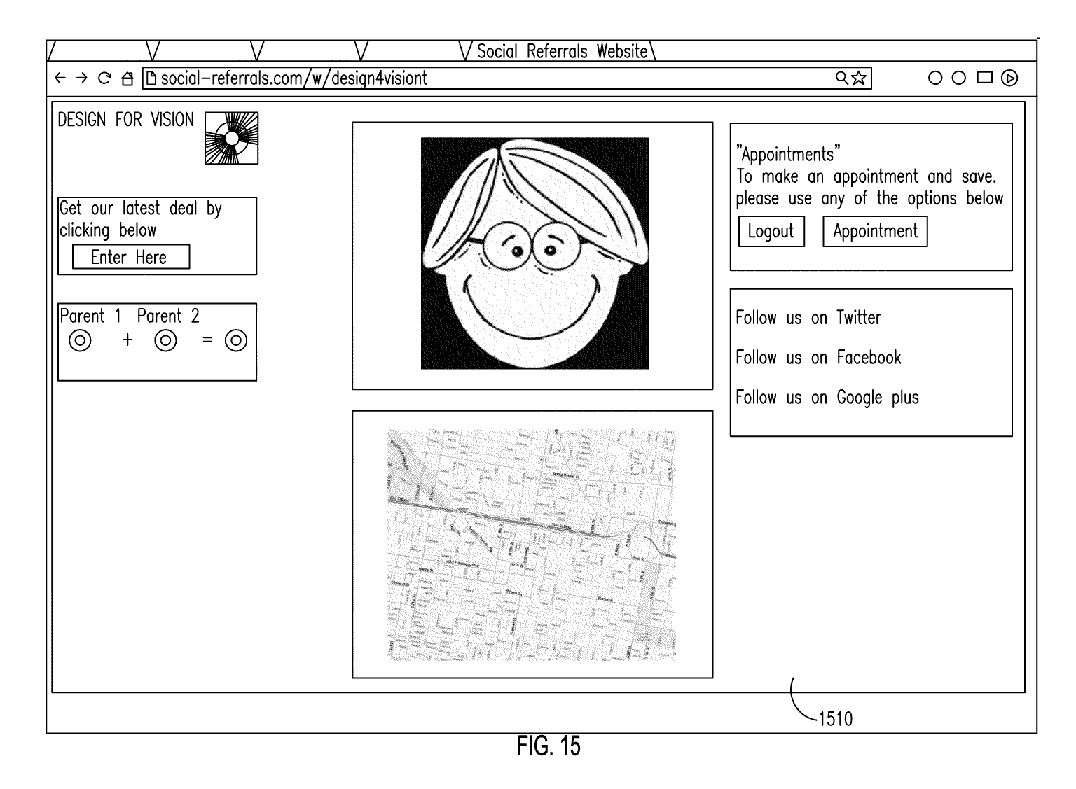

FIG. 15 illustrates an example of a web page which contains remarketing code. The web page may be a landing page or an HTML version of the marketing communication. The customer user may click on a part of the web page 1510 to activate the remarketing code. The customer user may then receive advertisements. In a further example, the administrative user may select additional preferences 1280. In a further example, the platform may receive an indication that the customer user has visited the web page 1510.

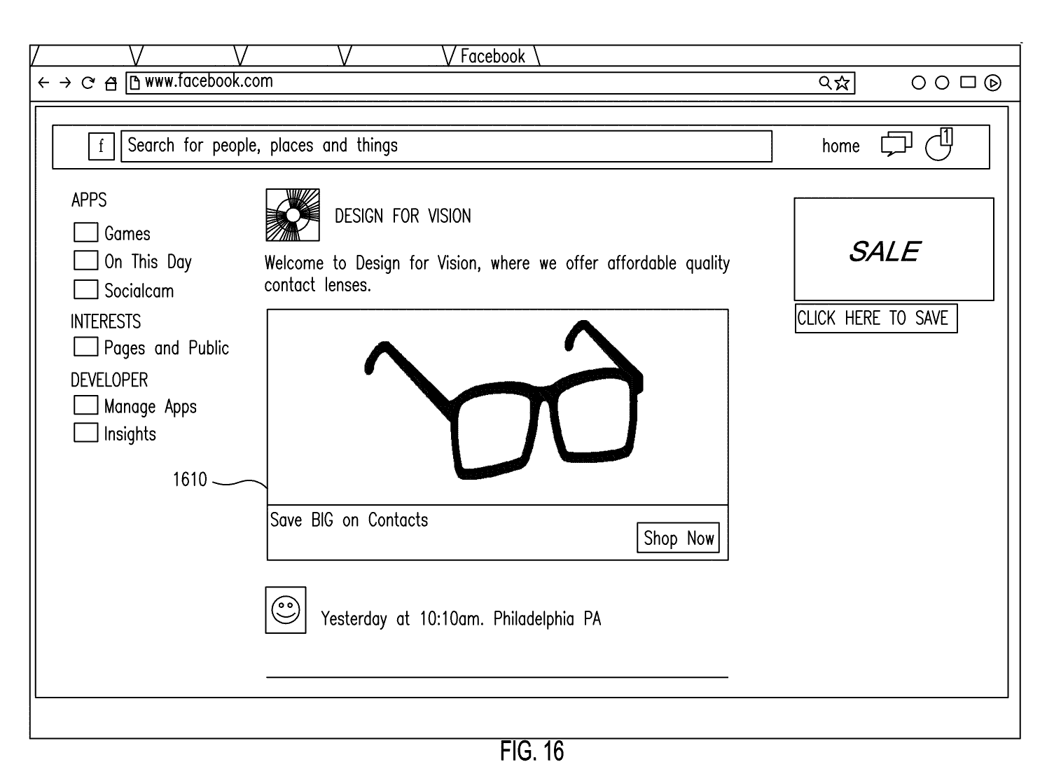

FIG. 16 illustrates an example of an advertisement received by a customer user. The advertisement 1610 may appear on the customer user's social media profile page 1600. Both the customer user and the social media friends or followers may receive or view the advertisement 1610.

In a further example, if a patient or a customer were to click on a business that was listed as a social referrals business, that business may receive a notification that their business was viewed. These notifications may show up in the dashboard of the business on the software application. Businesses may be able to create promotions or offers that they can specifically put on the social referrals network as well. The business-to-business network may have certain triggers that use demographics, location, and/or business type to trigger the user to communicate.

For example, if an eye doctor lives in Washington, his business network may display other eye doctors in that area so he can communicate with or see what they are doing. There may also be logic within the marketing module that allows businesses to choose products from vendors that they want and build shopping carts that the vendors will be able to view.

The mobile site or mobile packager module may pull or extract information from the user's profile. It may pull business information, social networks, appointment times, phone numbers and e-mails, reviews, and their current offers, and put them into a mobile website. The review and survey module may be triggered by appointments. As an appointment is finished, it may trigger some sort of communication to go out to the patient or customer to review that business.

A payroll module may be triggered by employee information and time related events, and may integrate with payroll companies. If employee hours are not received, for example, it may trigger a communication to be sent out to the employee. The computer tablet provided for each office, such as computer tablet 300, may automatically post to customers profiles and collect patient info, which populates the system. The reputation monitoring system may use APIs to collect information about businesses on the internet and alert them when they are mentioned.

The results module may pull information from all the other modules. Every communication, transaction, click, and the like can trigger a notification in the results module. For example if a business sold X amount of widgets because their business was clicked on in a social referrals network, that may trigger a certain response in the results module. If an appointment was scheduled and the practice received $500 from the appointment, it would register as a result.

The enterprise management platform disclosed herein can produce emails, newsletters, text messages, advertisements, mobile websites, and reports. In addition, the enterprise management platform could be used by third party marketing agencies to perform marketing activities for their customers. The enterprise management platform could be packaged with existing customer relationship management software to expand the capabilities of their software. The enterprise management platform could also be used as a tool to by enterprises to communicate to their employees.

The social referrals platform 130 may operate in conjunction with the enterprise management platform or on a stand-alone basis. Further, the social referrals platform 130 may operate as a cloud based mobile application. In an example, the customer user may obtain deals using the social referrals platform 130. For example, communications, advertisements (including advertisements presented in the physical world, such as, for example, store displays, periodical or circular advertisements or handouts) or social media postings may contain links or quick response (QR) codes or both. The customer user may click on the link or scan the QR code to arrive at the social referrals platform. For example, the customer user may be directed by the social referrals platform to navigate to the social referrals platform's landing page. As a further example, the customer may log onto a social media platform. The customer may accept the permissions settings requested by the social referrals platform and allow the social referrals platform to receive information from the social media platform concerning the customer user, including, for example, the customer user's public profile, friends list, email address, custom friends list, likes and other information. Further, the customer user may allow the social referrals platform to post to the customer user's profile page or timeline or both.

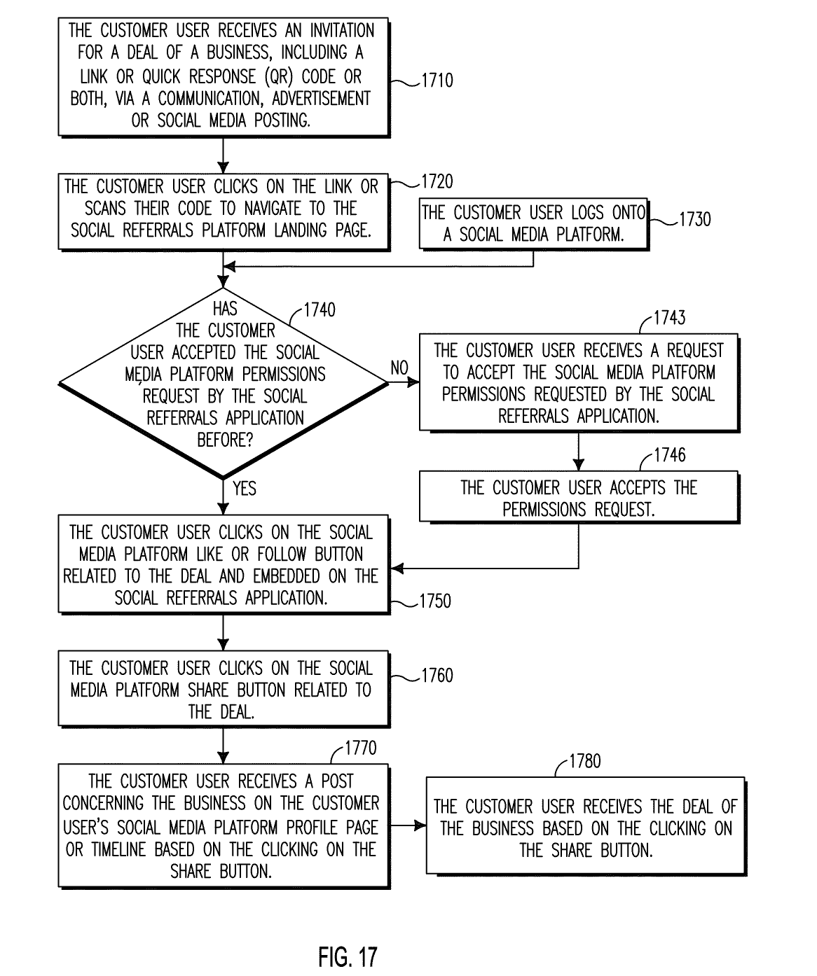

FIG. 17 illustrates an example of a process where the customer user may obtain deals using the social referrals platform. In the example process, the customer user may receive an invitation for a deal of a business via a communication, advertisement or social media posting 1710. The customer user may then click on the link or scan the QR code to arrive at the social referrals platform 1720. For example, the customer may navigate to the social referrals platform's landing page.

In an example, the customer user may then log onto a social media platform 1730. In an alternative example, the customer user may log onto a social media platform before receiving the invitation for a deal and may remain logged on when completing the rest of process.

If customer has accepted the social media platform permissions requested by the social referrals application before 1740, the customer may then receive a web page containing a like or follow button related to the deal. The like or follow button may be embedded on the social referrals application. If the customer has not accepted the social media platform permissions requested by the social referrals application before 1740, the customer may then receive a request to accept the social media platform permissions requested by the social referrals application 1743. The customer user may then accept the permissions request 1746 and the social referrals application may receive the acceptance. The social referrals application may then transmit and the customer may receive the web page containing the like or follow button related to the deal.

The customer user may then click on the social media platform like or follow button related to the deal 1750. The social referrals platform may receive an indication that the customer user clicked on the like or follow button. Further, the customer user may click on the social media platform share button related to the deal 1760. The social referrals platform may receive an indication that the customer user clicked on the share button. Afterward, the social referrals platform may transmit, and customer user may receive, a post concerning the business on the customer user's social media platform profile page or timeline based on the clicking on the share button 1770. The customer user may receive the post without providing further information to the social media platform or social referrals application. In an example, the post may contain one or more of the business' message, image and link to a deal. In addition, the social referrals platform may transmit and the customer user may receive the deal of the business 1780. As discussed further below, the deal may or may not include a coupon. Further, the customer user may receive the deal without providing further information to the social media platform or social referrals application. In an example, the prospect of receiving the deal may provide an incentive for the customer user to click the share button.

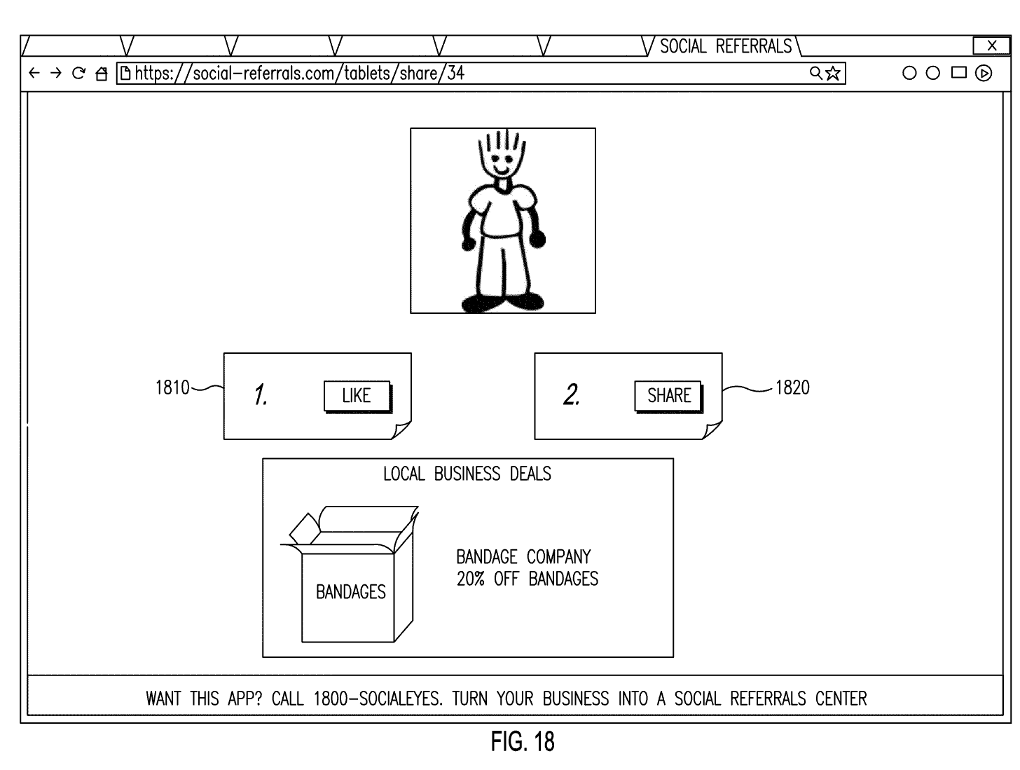

FIG. 18 illustrates an example of a web page transmitted by the social referrals application displaying like and share buttons related to a deal. In an example, the customer user may click on the like button related to the deal 1810 and the social referrals application may receive an indication of the click. In another example, the button may be a follow button related to the deal. Then, the customer user may click on the share button related to the deal 1820 and the social referrals application may receive an indication of the click.

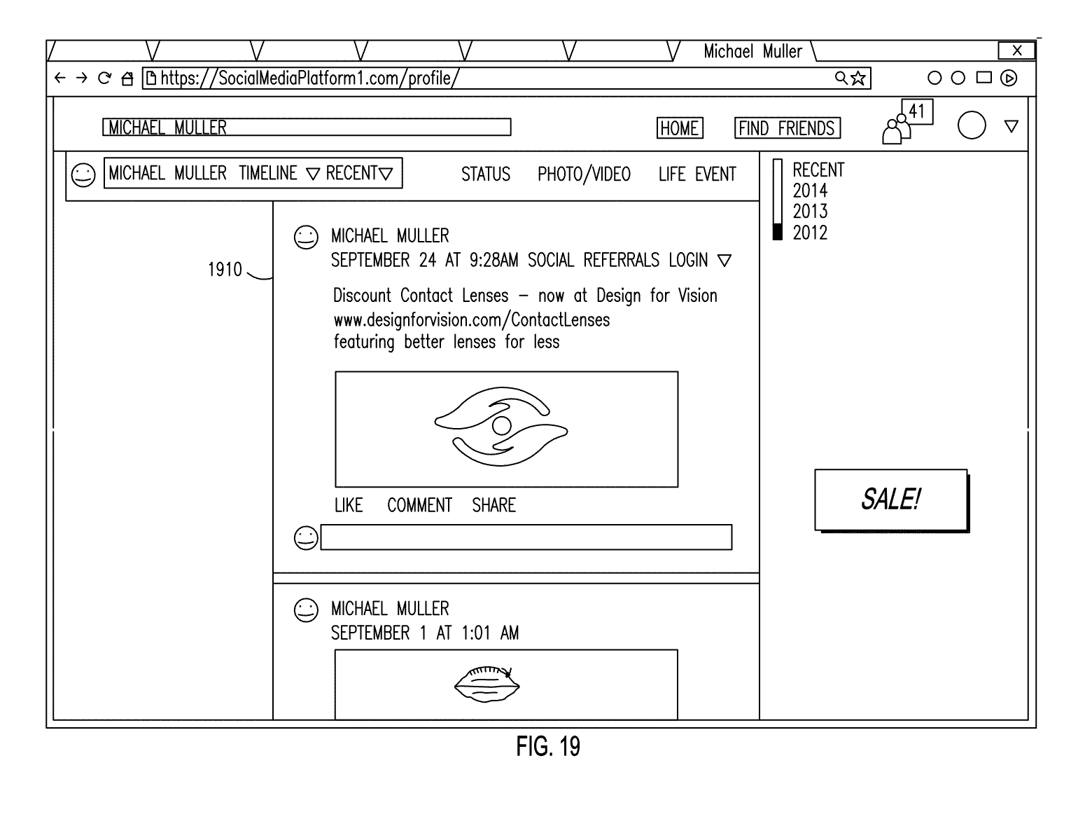

FIG. 19 illustrates an example of a customer user's timeline on a social media platform displaying a post related to a deal. The post 1910 may be transmitted by the social referrals application after the customer user clicks on the share button related to the deal. In a further example, the post concerning the business may be viewed by the social media friends or followers of the customer user. The customer user may not change the message, which is controlled and generated by the administrative user of the business using the social referrals platform, as described herein. In this way, the business' brand message may be accurately portrayed and delivered by the social referrals platform to the customer user's friends or followers. In yet a further example, the post may include an invitation for the deal or another deal which those friends or followers may activate to navigate to the social referrals platform landing page and access one or more deals themselves. The friends or followers may have the option to receive the one or more deals as well, by sharing the one or more deals in turn. In a further example, the customer user, friends or followers may also automatically be served with the advertisements triggered by a remarketing code placed on the social referrals platform's landing page.

In a further example, a customer user may click the share button related to the deal multiple times. As a result, for each click of the share button, the social referrals application may transmit and the customer user may receive a post concerning the business displayed on the customer user's social media platform profile page or timeline based on the click. Each of the posts may also be viewed by the customer user's friends or followers. Also, the social referrals platform may transmit and the customer user may receive a deal for each click of the share button. After the first like or follow button click related to a deal, the social referrals platform may deactivate the customer user's like or follow button related to the deal. As a result, the customer user may no longer click the like or follow button related to that deal. In this way, the customer user may not accidentally unlike or unfollow the deal. Accordingly, the social referrals platform may display the like or follow button with a “skip” notice so that the customer user does not click it again.

In a further example, a customer user may click the share button related to the deal multiple times before receiving a post concerning the business or the deal transmitted by the social referrals platform. As explained further below, the administrative user of the business may use the social referrals platform to set the number of shares required before the customer user receives the post or deal. For example, the customer user may be required by the social referrals platform to click the share button three times before receiving the post and the deal. Further, the customer user may be required to only click the share button once per a certain time period (for example, once per day or once per week). In this example, once the customer user satisfies the share button requirements of the social referrals platform set by the administrative user, the customer may receive the post and the deal, including a coupon, transmitted by the social referrals platform.

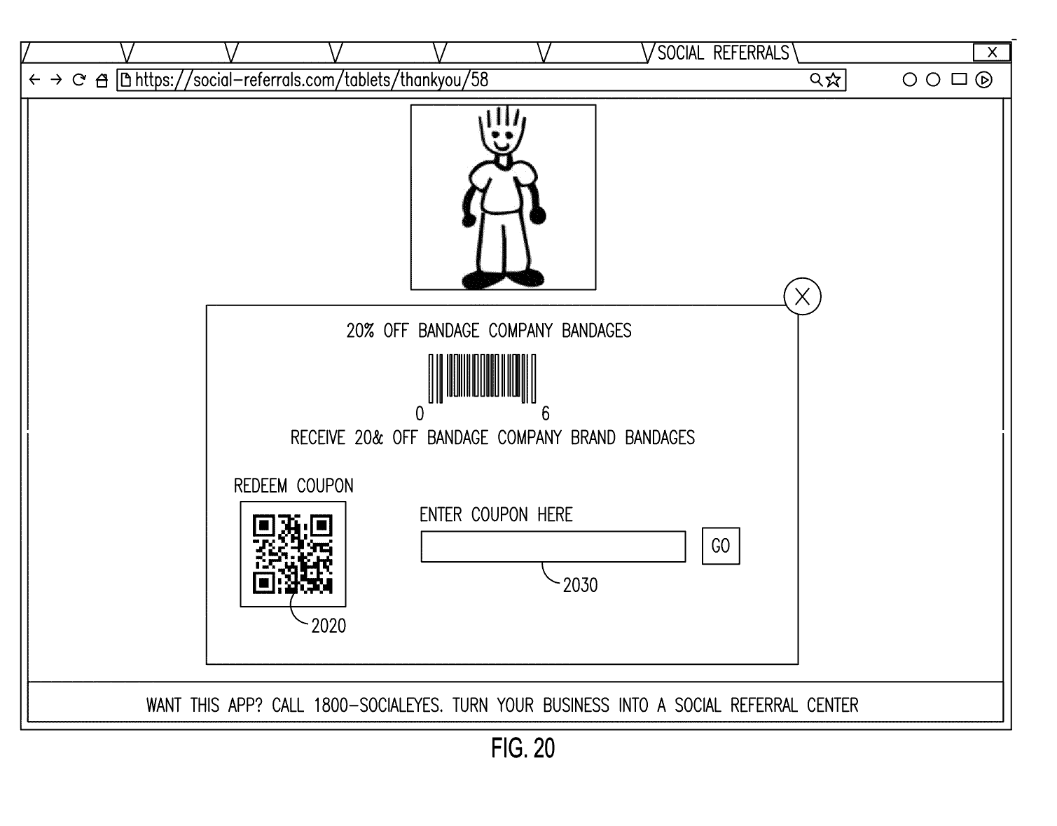

FIG. 20 illustrates an example of a coupon related to a deal. In an example, the coupon may include a QR code 2020 which a customer user may display on a tablet computer or smartphone at the retail location of a business in order to redeem the coupon. In a further example, the coupon may include a text box 2030 for the customer user to enter a coupon code to redeem the coupon. Through coupon redemption, the social referrals application may record which deal was used and which store redeemed the coupon. In an example, the social referrals application may prevent a customer user from using the same type of coupon more than a certain number of times, such as, for example, more than once.

In a further example, a customer user may click on the share button and then receive a confirmation page from the social referrals platform indicating that the share button has been clicked. The customer user may show this confirmation page, displayed, for example, on the customer user's tablet computer, smartphone or similar device, to the business in a retail location. The business may then provide the deal to the customer user.

In a further example, the customer user may receive one or more further invitations to deals related to local businesses. As explained further below, the administrative user of the business may provide settings for the social referrals platform to determine which local business invitations to transmit to the customer user. The customer user may access these further deals in a similar manner to the earlier deals, as described herein.

In a further example, after the customer user clicks on the share button of further invitations for deals, the social referrals application may delay the posting of those businesses to the customer user's profile page or timeline so that the earlier business posting is highlighted by its prominence and not overshadowed by the later business postings. The business posting may include invitations for deals.

In a further example, after clicking the share button, the social referrals platform may transmit and the customer user may receive an email related to the business. The email may include one or more of the following: the deal described in the invitation, another invitation for a deal related to the business, a newsletter, an announcement, a thank you message, an invitation to provide feedback or other communication related to the business.

In a further example, the profile page or timeline of the business may display a post, transmitted by the social referrals platform, related to the invitation, after the customer clicks on the share button. The post may describe that the customer accessed the deal and include a link or QR code or both which friends or followers of the business may activate to access the deal themselves, as described above.

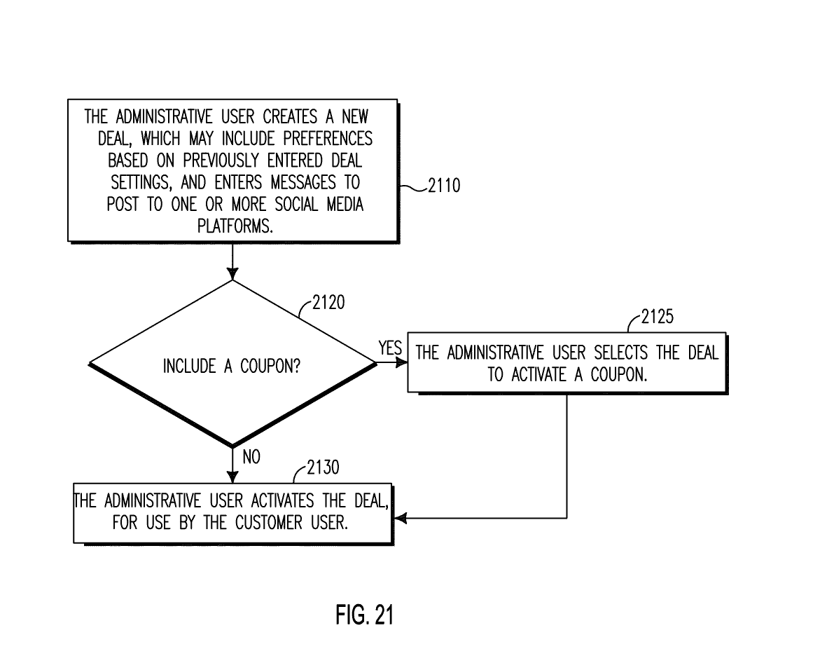

FIG. 21 illustrates an example of a process where the administrative user may create and activate new deals using the social referrals platform. The administrative user of a business may use the social referrals platform to create a new deal for the business and enter messages to post to one or more social media platforms 2110. The new deal may include preferences, such as date limitations on use of the deal, based on deal settings an administrative user previously entered into the social referrals platform on behalf of the business, as described further below. The administrative user may decide whether to include a coupon with the deal 2120. If the administrative user decides to include a coupon, the administrative user may use the social referrals platform to select a deal to activate the coupon 2125, as described further below. When the administrative user is satisfied with the deal and ready to use it, the administrative user may activate the deal 2130.

The social referrals platform may then transmit the deal, including a link or a QR code, to customer users through a variety of methods. The social referrals platform may, for example, email the deal to the customer user or transmit the deal to a social media platform of someone the customer user is friends with or follows. The social referrals platform may transmit the deal to multiple social media platforms automatically, as described herein. The administrative user may also use the social referrals platform to print out an advertisement with a QR code that the customer user may access with a computer tablet or smartphone.

In an example, the administrative user may manage the previously created deals using the social referrals platform. The administrative user may change the status of deals from active to inactive and back again. Further, the administrative user may set a time limit on a deal so that the social referrals platform will automatically switch the status of the deal from active to inactive, or vice-versa.

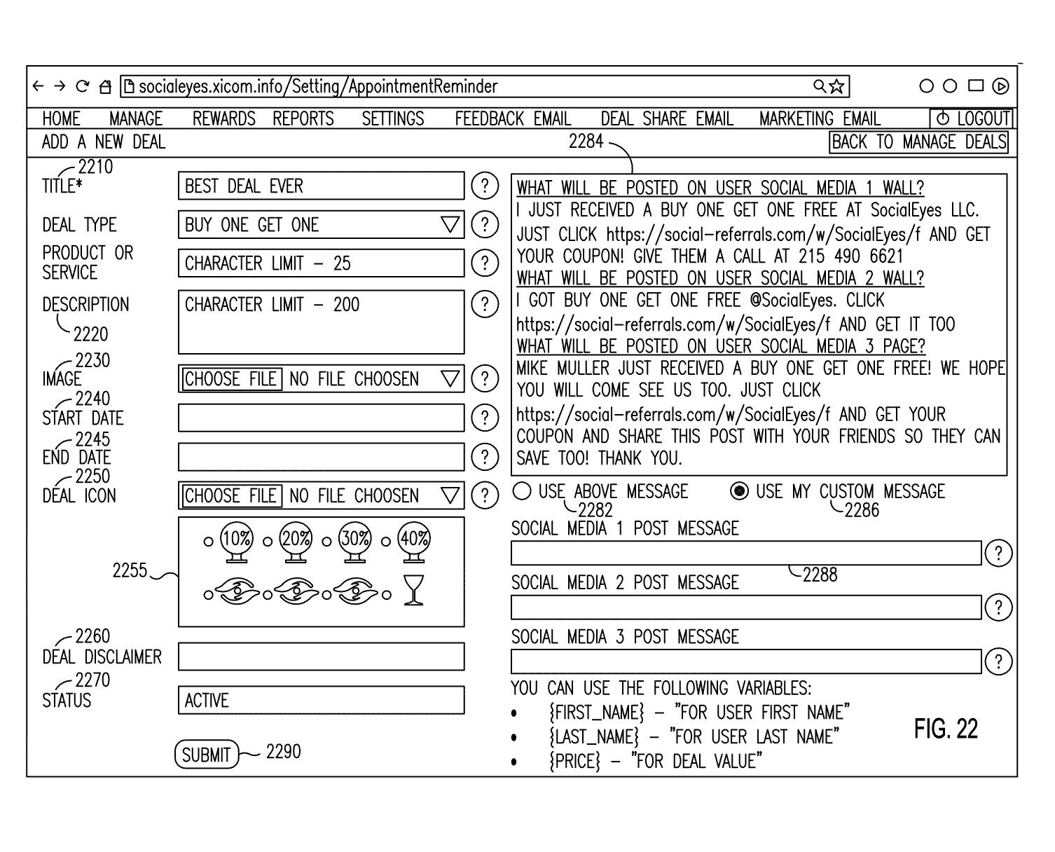

FIG. 22 illustrates an example of a web page where an administrative user may create a deal using the social referrals platform. The administrative user may enter a title for a deal 2210 and a deal description 2220. Further, the administrative user may upload an image file 2230 for the social referrals platform to transmit as part of the deal. In an example, the administrative user may set a start date 2240 and end date 2245 for the deal. The social referrals platform may set the status of the deal as active between those dates and as inactive before the start date 2240 and after the end date 2245. In a further example, the administrative user may use the social referrals platform to run the deal continuously.

Further, the administrative user may upload a deal icon 2250 file for the social referrals platform to transmit as part of the deal. The administrative user may use an image file for the deal icon or use radio button to select a variety of available image icons 2255. In addition, administrative user may add a deal disclaimer 2260. Further, the administrative user may set the initial status of the deal to active or inactive 2270. For example, the administrative user may create a deal to be saved on the social referrals platform and used later, and may therefore set an initial status of the deal as inactive.

In an example, the administrative user may use messages provided by the social referrals platform 2284 by clicking the radio button for those messages 2282. The messages 2284 may be transmitted with the deal by the social referrals platform to multiple social media platforms automatically. In a further example, the administrative user may use custom messages 2286, entered by the administrative user in text boxes set for different social media platforms, such as text box 2288. When the administrative user is satisfied with the deal, the administrative user may click the submit button 2290.

In a further example, the administrative user may set a deal type. In an example, the deal types may include Percentage, Dollar, Buy One Get One and Other. The administrative user may also enter an amount in a Deal Value field, if applicable, and a description of the product or service related to the deal in a Product or Service field. The social referrals platform may generate an automatic post message based on the deal type and product or service. For example, under deal type Percentage, a value of 20% may be entered in Deal Value field and “contact lenses” may be entered in the product or service field. As a result, the automatic post message may be “I just saved 20% off contact lenses.”

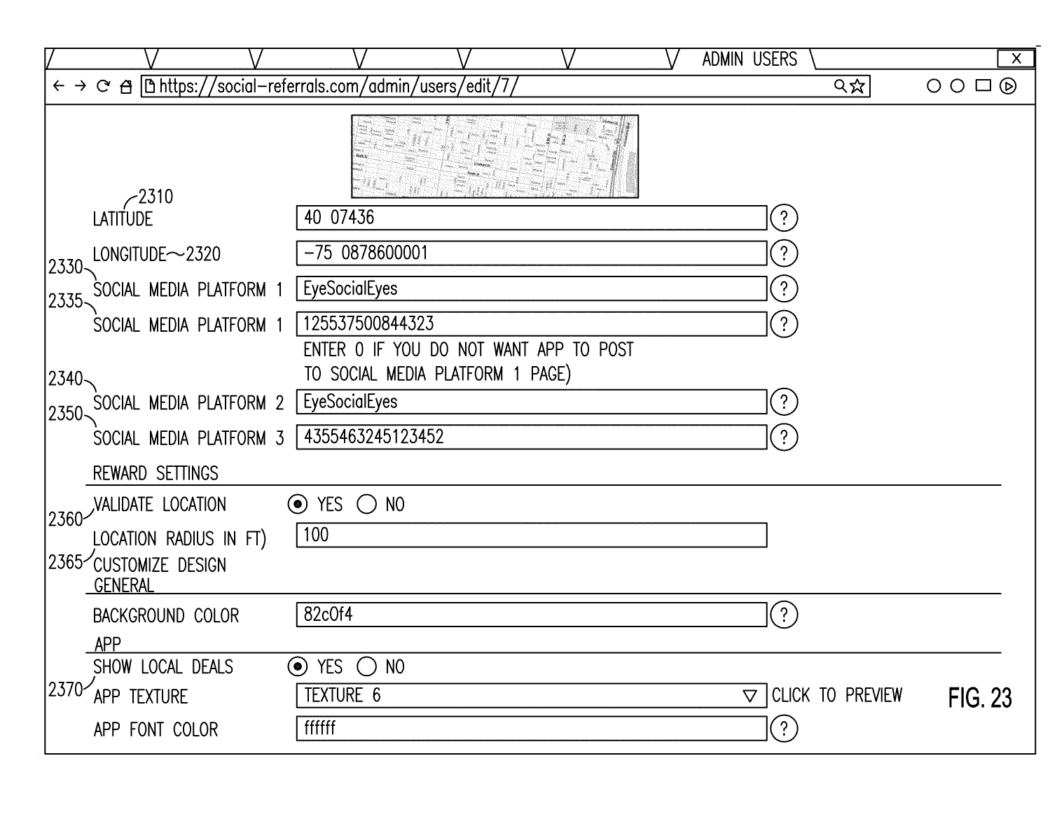

FIG. 23 illustrates an example of a web page where an administrative user may enter general deal settings using the social referrals platform. The social referrals platform may apply the general deal settings to all deals for a business. In an example, the social referrals platform may provide an initial latitude 2310 and longitude 2320 of a business using a mapping platform, such as, for example, GOOGLE MAPS. The administrative user may adjust the initial latitude 2310 and longitude 2320. The administrative user may enter the business identifiers for various social media platforms 2330, 2335, 2340, 2350. Further, administrative user may determine whether use of deals may be location dependent based on the validation location 2360. For example, administrative user may set a maximum location radius 2365 from a business location for the use of the deal. In a further example, the administrative user may direct the social referrals platform to show local deals 2370 to the customer user after the customer user may have shared an initial deal, as described herein. The social referrals platform may use the latitude 2310 and longitude 2320 of a business to determine the business' location in order to apply the location radius 2365 and local deals 2370 settings.

In a further example, an administrative user may use the social referrals platform to create an email to send to customer users with an invitation for a deal. The administrative user may enter text and upload images for use the email. The administrative user may save the email for later editing and use. The social referrals platform may transmit the email to customer users when the deal is active.

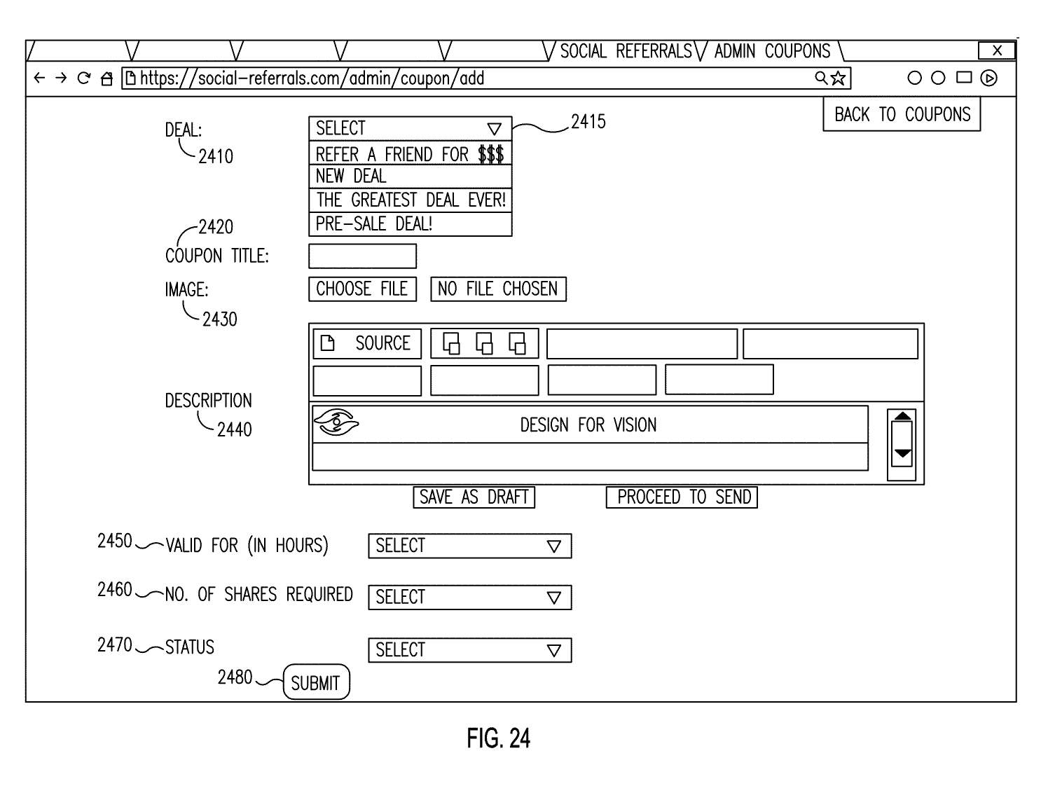

FIG. 24 illustrates an example of a web page where an administrative user may add a coupon to more or more deals using the social referrals platform. The administrative user may select a deal 2410 to add a coupon to, from a drop-down box 2415 in which the social referrals platform populates previously created deals. In an example, the social referrals platform may populate the drop down box 2415 only with deals that have a status of active. The administrative user may add a title to the coupon 2420. Further, the administrative user may upload an image file 2430 and add a description 2440 for the social referrals platform to transmit as part of the coupon. In an example, the administrative user may set restrictions on the use of the coupon, such as the coupon may be valid for only a certain period of time 2450 or may require a certain number of clicks of the share button 2460 before being used, as described above. The administrative user may set a status of the coupon 2470 as active or inactive. When the administrative user is satisfied with the coupon settings for the deal, the administrative user may click on the submit button 2480. The social referrals platform may then associate the coupon with the deal.

In a further example, the social referrals platform may generate a deals report for the administrative user which indicates the total number of view and shares for each deal. Further, the social referrals platform may provide a deals report which shows information about each share of each customer user, including, for example, the date and time of the share, the social media platform used for the share and the number of friends or followers of the customer user.

The enterprise management platform may use PHP Hypertext Preprocessor (PHP) to post a communication to a social media profile. The enterprise management platform may use PHP with the social media platform's software development kit (SDK) or API or both to make a request against the social media platform's API. The social media platform may then look for an active session validated by using an access token and an application identification. This request may await a response from the platform's API which may either allow the enterprise management platform to publish to the user's timeline or deny publishing due to an inactive session or insufficient permissions provided by the user.

The enterprise management platform may place advertisements on a social media platform, whose advertisement API may allow the enterprise management platform to create and access advertisements programmatically. In an example, the enterprise management platform may choose an advertisement objective based on the results that an administrative user wants from an advertisement. The enterprise management platform may then authenticate the session and an administrative user then creates an objective and constructs the API calls needed to create a campaign, advertisement set, and advertisement on the platform. The user may fill out the parameters for these API calls. The enterprise management platform may use the platform's creative selection interface, broken down into three sections—the advertisement creative itself, defined by the visual attributes of the creative object; the placement that the advertisement will run on; and the preview of the unit itself, per placement.

The enterprise management platform may then use the targeting options in the API. Targeting may be redefined as four key areas—interests, demographics, behaviors and locations. The enterprise management platform may then configure the bidding options, asking the administrative user for a desired action (click, view, etc.) and setting a budget limit.

To construct the advertisement management user interface (UI) the enterprise management platform may use the social media platform's API to fetch objects so as to display the status and basic information of each object in a management dashboard. The enterprise management platform may use the Ad Report Stats API to retrieve the advertisements data in flexible ways to fulfill the reporting objectives. It may allow querying, filtering, grouping and sorting for the reporting system. The API may also run reports asynchronously and retrieve results when they are available. The API may also allow scheduling of reports and notify the user via email when new report data is available.

Although features and elements are described herein in particular combinations, each feature or element can be used alone or in any combination with or without the other features and elements. For example, each feature or element as described above with reference to any Figure or any combination of Figures may be used alone without the other features and elements or in various combinations with or without other features and elements. Sub-elements and/or sub-steps of the methods described herein with reference to any Figure or any combination of Figures may be performed in any arbitrary order (including concurrently), in any combination or sub-combination.

What is claimed is:

1. A computer based method for communicating with customer users, the method comprising:
generating, by a processor, a communication including an invitation for a deal of a business and a link to a web page;
transmitting, by the processor, the communication via email or posting to one or more social media platforms or both;
receiving, by the processor, an indication that a customer user has visited the web page;
receiving, by the processor, an indication that the customer user has accepted a set of permissions for one of the social media platforms;
transmitting, by the processor, a web page including a like or follow button and a share button, wherein the buttons are related to the deal;
receiving, by the processor, an indication that the customer user has pressed the like or follow button;
receiving, by the processor, an indication that the customer user has pressed the share button; and
transmitting, by the processor, the deal for the customer user based on the receipt of the share button indication.

2. The method of claim 1 wherein the web page is a landing page.

3. The method of claim 1 further comprising:
transmitting, by the processor, a first post concerning the business for the profile page or timeline of the customer user based on the receipt of the share button indication.

4. The method of claim 1 further comprising:
transmitting, by the processor, a second post concerning the business for the profile page or timeline of the business based on the receipt of the share button indication.

5. The method of claim 1 further comprising:
transmitting, by the processor, a confirmation page concerning the business based on the receipt of the share button indication.

6. The method of claim 1 further comprising:
transmitting, by the processor, an email concerning the business for the customer user based on the receipt of the share button indication.

7. The method of claim 6 wherein the email includes one or more of the following: the deal described in the invitation, another invitation for a deal related to the business, a newsletter, an announcement, a thank you message, an invitation to provide feedback or other communication related to the business.

8. The method of claim 1 wherein the deal is a coupon.

9. The method of claim 8 wherein the coupon includes a date restriction or location restriction or both.

10. A non-transitory computer readable storage medium having processor-executable instructions stored thereon which, when executed by at least one processor, will cause the at least one processor to perform a method for communicating with customer users, the method comprising:
generating a communication including an invitation for a deal of a business and a link to a web page;
transmitting the communication via email or posting to one or more social media platforms or both;
receiving an indication that a customer user has visited the web page;
receiving an indication that the customer user has accepted a set of permissions for one of the social media platforms;
transmitting a web page including a like or follow button and a share button, wherein the buttons are related to the deal;
receiving an indication that the customer user has pressed the like or follow button;
receiving an indication that the customer user has pressed the share button; and
transmitting the deal for the customer user based on the receipt of the share button indication.

11. The non-transitory computer readable storage medium according to claim 10 wherein the web page is a landing page.

12. The non-transitory computer readable storage medium according to claim 10 wherein the method further comprises:
transmitting a first post concerning the business for the profile page or timeline of the customer user based on the receipt of the share button indication.

13. The non-transitory computer readable storage medium according to claim 10 wherein the method further comprises:
transmitting, a second post concerning the business for the profile page or timeline of the business based on the receipt of the share button indication.

14. The non-transitory computer readable storage medium according to claim 10 wherein the method further comprises:
transmitting a confirmation page concerning the business based on the receipt of the share button indication.

15. The non-transitory computer readable storage medium according to claim 10 wherein the method further comprises:
transmitting an email concerning the business for the customer user based on the receipt of the share button indication.

16. The non-transitory computer readable storage medium according to claim 15, wherein the email includes one or more of the following: the deal described in the invitation, another invitation for a deal related to the business, a newsletter, an announcement, a thank you message, an invitation to provide feedback or other communication related to the business.

17. The non-transitory computer readable storage medium according to claim 10 wherein the deal is a coupon.

18. The non-transitory computer readable storage medium according to claim 17 wherein the coupon includes a date restriction or location restriction or both.

19. A computer based method for communicating with customer users, the method comprising:
receiving, by a processor, a set of indications of an administrative user regarding a deal related to a business for customer users;
generating, by the processor, a deal based on the set of indications of the administrative user;
receiving, by a processor, an activation indication of the administrative user to activate the deal for use by the customer users; and
transmitting, by the processor, the deal to at least one customer user.

20. The method of claim 19 wherein the deal includes the coupon.
